(19) United States
(12) Patent Application Publication
(10) Pub. No.: US 2004/0174625 A1
(43) Pub. Date: Sep. 9, 2004

(54) STRENGTHEENED MIRROR STRUCTURE

(76) Inventors: Chih-Chung Kang, Miao- Li Hsien (TW); Yung-Chuan Tseng, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,196

(22) Filed: Feb. 15, 2004

(30) Foreign Application Priority Data
Mar. 5, 2003 (TW) 092203624

(51) Int. Cl. G02B 5/08

(52) U.S. Cl. 359/883; 359/871

(57) ABSTRACT

A strengthened mirror structure includes a reflection mirror with a reflection surface and a back surface respectively at the opposite sides thereof, and at least one strengthening element such as a honeycomb plate. An adhesive is used to stick the strengthening element on the back surface of the reflection mirror. Whereby, the bending-resistant capability of the reflection mirror while being suspended in midair is enhanced so as to prevent the mirror from deforming and further to enhance a picture quality, and the safety problem about mirror cracking can be guarded against so as to improve a product quality.

### BACKGROUND OF INVENTION

1. Field of the Invention

The present invention relates to a strengthened mirror structure, more particularly to a structure for enforcing the strength of a mirror in a back projection display device.

2. Description of the Prior Art

Recently, the faster the development of photoelectric technology is, the more important information visualization is. And, the importance and the requirement of a back projection television regarded as a display device are increased rapidly. Therefore, under the consideration of mass production, how to increase the strength of a mirror structure of the back projection television and further to enhance market competition capability has already become an important subject of industry-wide research and development.

Please refer to FIG. 1. A screen 11 at the front of a conventional back projection television 10, a base seat 12 at the bottom thereof and a back cover 13 at the rear side thereof are used to from an inner portion of the back projection television 10. An accepting seat 14 is installed on the base seat 12 at the inner portion of the back projection television 10. An optical engine 15 is further installed on the accepting seat 14 and a small reflection mirror 16 is installed in front of the optical engine 15 and at one end of the accepting seat 14. Moreover, a large reflection mirror 17 is installed inside of the back cover 13 behind the screen 11. The optical engine 15 is mainly used to yield beams with image information in the back projection television 10. The beams are further projected onto the screen 11 through the large projection mirror 17, after the yielded beams are projected to the small reflection mirror 16 and the large reflection mirror 17 in a sequence. Whereby, an optical system is thus formed in the back projection television.

As FIG. 2 shows, the large reflection mirror 17 of the back projection television 10 is merely clipped by locking elements 18 respectively at two ends thereof for allowing the broadest range of the image information beams to be reflected from the mirror face thereof and to be projected onto the screen and the large projection mirror to be extended and shrunk properly owing to hot expansion and cold shrinkage. But, fixing the large reflection mirror 17 suspended in midair at the back cover 13 leads to a situation that the span between two ends of the large reflection mirror 17 is overlarge. The large reflection mirror 17 is easy to be pulled by gravity force to form a deformation 17″, because no supporting element exists in the middle of the large reflection mirror. Especially, the larger the dimension of the back projection television 10 is, the larger the dimension of the large reflection mirror 17 is and the more serious the deformation situation of the mirror is; this will influence the quality of the picture of the back projection television 10. In the meantime, because the deformation amount of the mirror is overlarge, the mirror is easy to get cracked by the shock formed in the middle of the assembly or the transportation of the projection television 10; this will lead to a higher production cost. Besides, that the mirror is cracked into many small pieces will make cleaning and maintenance difficult and safety unsecured.

### SUMMARY OF INVENTION

One object of the present invention is to provide a strengthened mirror structure, being able to increase a bending-resist capability of a mirror while being suspended in midair, to prevent it from deforming and further to enhance a picture quality through a strengthened structure at the back surface of the mirror.

Another object of the present invention is to provide a strengthened mirror structure, being able to increase anti-shock capability so as to prevent a mirror from cracking and further to lower down the production cost through a strengthened structure at the back surface of the mirror.

For attaining the objects mentioned above, a strengthened mirror structure according to the present invention comprises a reflection mirror having a reflection surface and a back surface respectively at the opposite sides thereof, and at least one strengthening element such as a honeycomb plate. An adhesive is used to stick the strengthening element on the back surface of the reflection mirror to enforce a bending-resist capability when the mirror is suspended in midair so as to prevent the mirror from deforming and further to enhance a picture quality. Meanwhile, a safety problem caused from a mirror cracking can be guarded against so as to enhance safety condition of persons while assembling and transporting.

### BRIEF DESCRIPTION OF DRAWINGS

The present invention can be more fully under by reference to the following description and accompanying drawings, in which:

FIG. 1 is a schematic view, showing an optical system of a conventional back projection television;

FIG. 2 is a schematic view, showing a mirror deformation of a conventional back projection television;

FIG. 3A is a schematic view, showing an outlook of a strengthened mirror structure of first preferred embodiment according to the present invention; FIG. 3B is a cross-sectional view, showing a strengthened mirror structure of first preferred embodiment according to the present invention;

FIGS. 4A and 4B are schematic views, showing an outlook of a strengthened mirror structure of second preferred embodiment according to the present invention; and

FIG. 5 is a cross-sectional view, showing a combination between a strengthened mirror structure and back cover according to second preferred embodiment of the present invention.

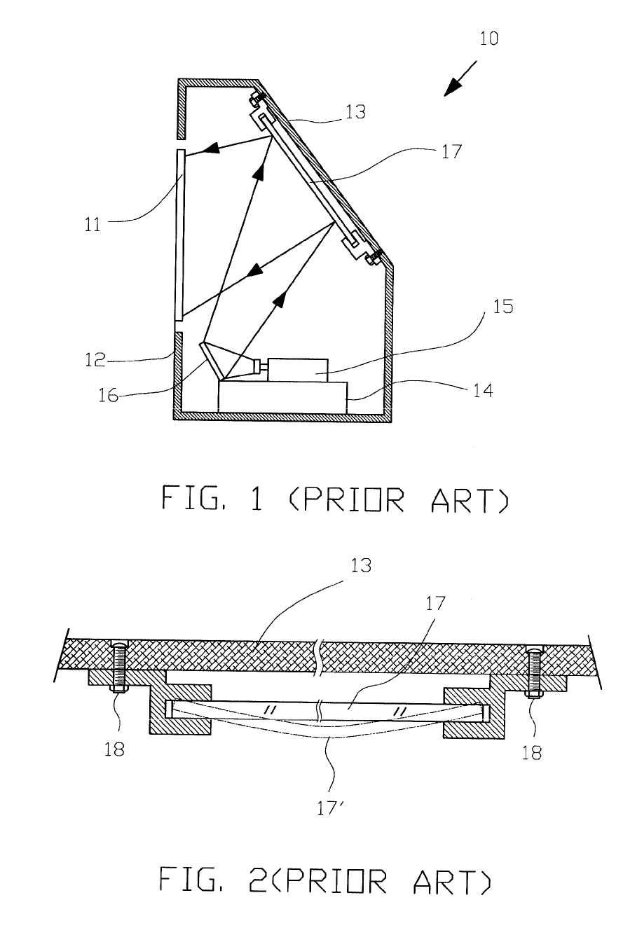

### DETAILED DESCRIPTION

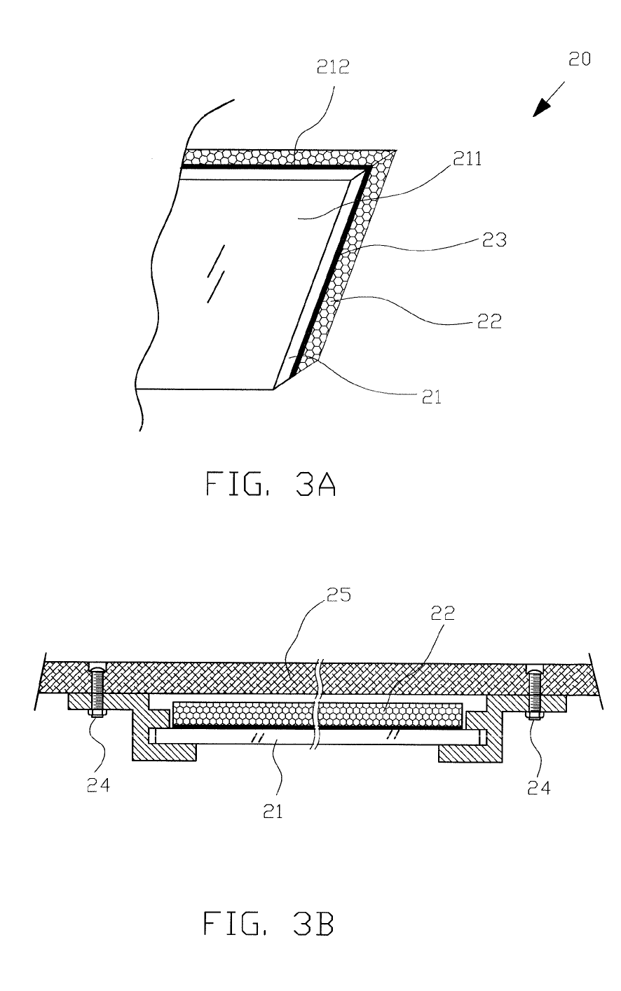

Please refer to FIG. 3A. FIG. 3A shows a strengthened mirror structure of first embodiment according to the present invention. A strengthened mirror structure 20 mainly comprises a large reflection mirror 21 and strengthening element 22, in which the large reflection mirror 21 has a reflection surface 211 and back surface 212. The reflection surface 211 is used to reflect image beams onto a screen (not shown in the figure), and an adhesive 23 (such as glue or adhesive tape) is used to stick a strengthening element 22 (such as honeycomb plate) on the back surface 212 to form a strengthened mirror structure 20.

As FIG. 3B shows, locking elements 24 are further used to fix the strengthened mirror structure 20 at the edges thereof onto a back cover 25. The material of honeycomb 22 used for the strengthening element 22 of the first embodiment is aluminum, one of other metals, paper or anything else. Because the honeycomb plate with hexagonal honeycombs structure has a characteristic of high stiffness, lightweight and etc, it can not only enhance the structure strength of the large reflection mirror 21 but also prevent the whole weight of a back projection television from being increased. And, the middle and the two ends of the large reflection mirror can get a fair supporting force by supporting a proper length of strengthening element 21 with the locking elements 24 at the two ends thereof; this can increase the bending-resistant capability of the large reflection mirror 21 after assembling to lessen the deformation thereof. Therefore, the distortion of reflected pictures can be lowered down so as to enhance a picture quality.

Besides, in the process of the assembly and the transportation of a back projection television, once an improper force is acted, the large reflection mirror 21 is unlikely cracked into many small spattered-around pieces when the large reflection mirror 21 is broken because the large reflection mirror 21 is stuck with the strengthening element 22. Therefore, safety can be insured for persons while assembling and transporting, and difficulty can be lessened while cleaning cracked glasses spread in a back projection television.

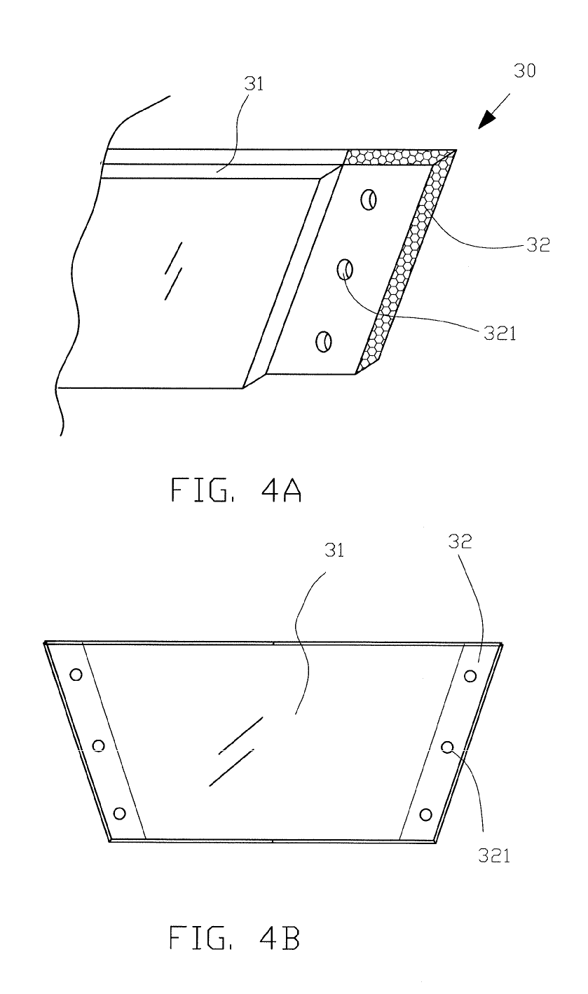

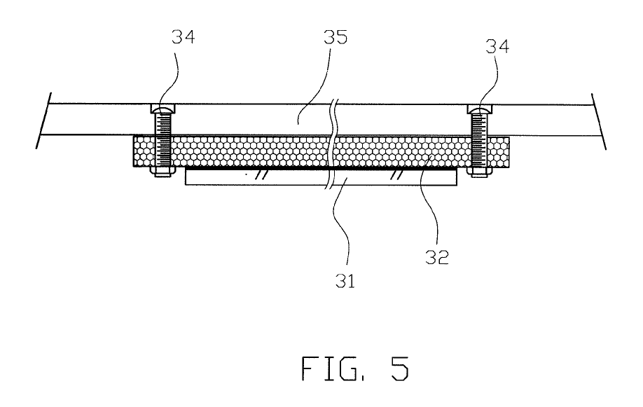

Please refer to FIGS. 4A and 4B. FIGS. 4A and 4B show a strengthened mirror structure of second preferred embodiment according to the present invention. The difference between first and second embodiments is the transverse width of a strengthening element 32 of a strengthened mirror structure 30, namely, the transverse width of the strengthening element 32 according to second preferred embodiment is broader than one of a large reflection mirror 31, and a plurality of screw holes for fixation are disposed at the two ends of the strengthening element 32. As FIG. 5 shows, locking elements 34 (such as screws) are used to simplify the fixing structure of the strengthened mirror structure 30 by passing the locking elements 34 through the screw holes 321 disposed on the strengthening element 32 to fix the strengthening element 32 onto a back cover 35.

It is noted that the strengthened mirror structure described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A strengthened mirror structure, comprising:
A reflection mirror, having a reflection surface and a back surface; and
At least a strengthening element, stuck on said back surface of said reflection mirror through an adhesive.

2. The structure according to claim 1, wherein said reflection mirror is a large reflection mirror.

3. The structure according to claim 1, wherein said reflection mirror is a small reflection mirror.

4. The structure according to claim 1, wherein said adhesive is glue.

5. The structure according to claim 1, wherein said adhesive is twin adhesive.

6. The structure according to claim 1, wherein said strengthening element is a honeycomb plate.

7. The structure according to claim 6, wherein said honeycomb plate is aluminum, one of other metals or paper.

8. The structure according to claim 1, wherein said strengthening element is smaller than said reflection mirror.

9. The structure according to claim 1, wherein said strengthening element is wider than said reflection mirror so as to form fixing ends.
